(19) United States
(12) Patent Application Publication
(10) Pub. No.: US 2007/0016657 A1
(43) Pub. Date: Jan. 18, 2007

(54) Multimedia data processing devices, multimedia data processing methods and multimedia data processing programs

(75) Inventor: Atsushi Ito, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/482,996

(22) Filed: Jul. 10, 2006

(30) Foreign Application Priority Data
Jul. 14, 2005 (JP) 2005-205619

(51) Int. Cl. G06F 15/16

(52) U.S. Cl. 709/219

(57) ABSTRACT

The present invention provides a multimedia data processing device, comprising: a template storing device which stores multimedia template data including media data and scenario data which defines the output aspects of the media data, a data input device which inputs media data for delivery to be delivered to a client terminal, a template specifying device which specifies multimedia template data to be used to create multimedia data using the input media data for delivery from among the stored multimedia template data, a media-data-for-exchange specifying device which specifies media data for exchange to be exchanged for the media data for delivery from among the media data included in the multimedia template data, and a multimedia data creating device which creates the multimedia data by exchanging the media data for exchange for the input media data for delivery.

### BACKGROUND OF THE INVENTION

1. Field of the Invention

The present invention relates to multimedia data processing devices, multimedia data processing methods and multimedia data processing programs, and more particularly to technologies for creating multimedia data using desired media data.

2. Description of the Related Art

Up to now, technologies for creating multimedia data to be provided over the Internet, etc., have been developed. For example, Japanese Patent Application Laid-Open No. 2003-281461 discloses a template file creating device for creating a multimedia template file whose post-editable range is predefined.

### SUMMARY OF THE INVENTION

The template file creating device disclosed in the above document, however, needed to individually edit the timings with which media data is reproduced or the selection of the media data to be reproduced with the specified timings using a dedicated authoring application. The authoring application used for creating multimedia data was so difficult to operate that even a simple editing operation, such as exchanging particular media data, could not be done without skills in operating the application.

The present invention has been made in consideration of the above described circumstances, and it is an object of this invention to provide multimedia data processing devices, multimedia data processing methods and multimedia data processing programs by which multimedia data can be easily created.

In order to achieve the above described object, a multimedia data processing device according to a first aspect of the present invention is characterized by comprising a template storing device which stores multimedia template data including media data and scenario data which defines the output aspects of the media data, a data input device which inputs media data for delivery to be delivered to a client terminal, a template specifying device which specifies multimedia template data to be used to create multimedia data using the input media data for delivery from among the stored multimedia template data, a media-data-for-exchange specifying device which specifies media data for exchange to be exchanged for the media data for delivery from among the media data included in the multimedia template data, and a multimedia data creating device which creates the multimedia data by exchanging the media data for exchange for the input media data for delivery.

According to the multimedia data processing device of the first aspect, simply by inputting media data for delivery and specifying multimedia template data, multimedia data in which part of the media data included in the multimedia template data has been exchanged can be automatically created.

A multimedia data processing device according to a second aspect of the present invention is characterized in that, in the first aspect, the media-data-for-exchange specifying device specifies as the media data for exchange the first or last media data included in the specified multimedia template data. The second aspect is intended to limit the procedure for specifying the media data for exchange.

A multimedia data processing device according to a third aspect of the present invention is characterized in that, in the first or second aspect, the media-data-for-exchange specifying device specifies as the media data for exchange the media data included in the specified multimedia template data in turn from the first or last media data.

A multimedia data processing device according to a fourth aspect of the present invention is characterized in that, in the first aspect, the media-data-for-exchange specifying device specifies as the media data for exchange the media data having a file size close to or smaller than the file size of the input media data for delivery among the media data included in the specified multimedia template data.

The fourth aspect is intended to limit the procedure for specifying the media data for exchange in the first aspect. According to the multimedia data processing device of the fourth aspect, the file size of the created multimedia data is close to or smaller than the file size of the multimedia template data. Thus, the file size may be adjusted in advance to the type of the receiving client terminal when the multimedia template data is created.

A multimedia data processing device according to a fifth aspect of the present invention is characterized by further comprising, in the first aspect, an operational input receiving device which receives operational input from a user, and in that the multimedia data creating device specifies as the media data for exchange the media data specified by the operational input.

According to the multimedia data processing device of the fifth aspect, the user can specify the media data for exchange. This can improve the degree of flexibility in creating the media data.

A multimedia data processing device according to a sixth aspect of the present invention is characterized in that, in the first to fifth aspects, the media data and the media data for delivery is at least one of character data, static image data, dynamic image data or audio data. The sixth aspect is intended to limit the type of the media data.

A multimedia data processing device according to a seventh aspect of the present invention is characterized by further comprising, in the first to sixth aspects, a file size adjusting device which performs at least one of compression, reduction, color subtraction, or bit rate adjustment so that the file size of the input media data for delivery is equal to or smaller than the file size of the media data for exchange to be exchanged for the media data for delivery.

According to the multimedia data processing device of the seventh aspect, the file size of the created multimedia data is equal to or smaller than the file size of the multimedia template data. Thus, the file size may be adjusted in advance to the type of the receiving client terminal when the multimedia template data is created.

A multimedia data processing device according to an eighth aspect of the present invention is characterized by further comprising, in the first to seventh aspects, an identifying device which identifies the type of the client terminal upon receipt of a request for delivery from the client terminal, a data converting device which converts the created multimedia data into the multimedia data in a format suitable for reproduction corresponding to the type of the client terminal, and a delivery device which delivers the converted multimedia data to the client terminal.

According to the multimedia data processing device of the eighth aspect, multimedia data which has been converted to be in a format or of a file size suitable for reproduction corresponding to the type of the client terminal can be delivered.

A multimedia data processing method according to a ninth aspect of the present invention is characterized by comprising the steps of storing multimedia template data including media data and scenario data which defines the output aspects of the media data, inputting media data for delivery to be delivered to a client terminal, specifying multimedia template data to be used to create multimedia data using the input media data for delivery from among the stored multimedia template data, specifying media data for exchange to be exchanged for the media data for delivery from among the media data included in the multimedia template data, and creating the multimedia data by exchanging the media data for exchange for the input media data for delivery.

A multimedia data processing program according to a tenth aspect of the present invention is characterized by causing a computer to implement the functions of storing multimedia template data including media data and scenario data which defines the output aspects of the media data, inputting media data for delivery to be delivered to a client terminal, specifying multimedia template data to be used to create multimedia data using the input media data for delivery from among the stored multimedia template data, specifying media data for exchange to be exchanged for the media data for delivery from among the media data included in the multimedia template data, and creating the multimedia data by exchanging the media data for exchange for the input media data for delivery.

By applying the multimedia data processing program according to the tenth aspect to, for example, a server for delivering contents over a network, the multimedia data processing device and the multimedia data processing method of the present invention can be accomplished.

According to the present invention, simply by inputting media data for delivery, multimedia data in which part of the media data included in the multimedia template data has been exchanged can automatically be created.

### BRIEF DESCRIPTION OF THE DRAWINGS

FIG. 1 is a block diagram illustrating the main components of a multimedia data processing device according to one embodiment of the present invention;

FIG. 2 schematically illustrates the structure of multimedia template data;

FIG. 3 schematically illustrates a multimedia data processing method according to a first embodiment of the present invention;

FIG. 4 schematically illustrates a multimedia data processing method where there are a plurality of images for delivery;

FIG. 5 schematically illustrates a multimedia data processing method according to a second embodiment of the present invention; and

FIG. 6 schematically illustrates the process of generating an image-for-exchange specifying file 66.

### DETAILED DESCRIPTION OF THE PREFERRED EMBODIMENTS

Preferred embodiments of multimedia data processing devices, multimedia data processing methods and multimedia data processing programs according to the present invention are now described below in regard to the accompanying drawings.

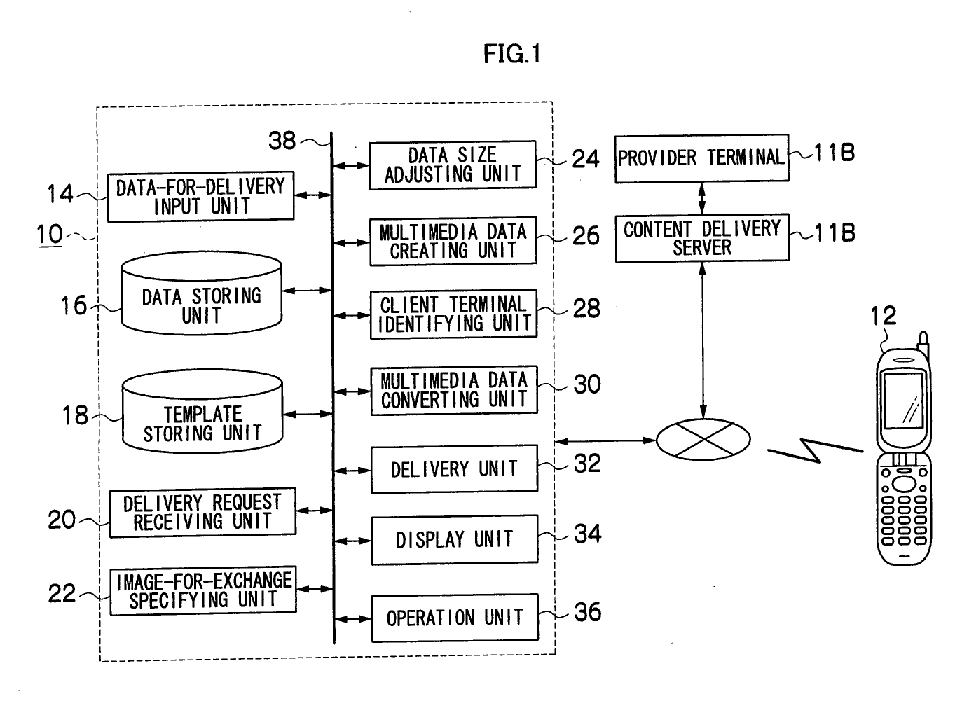

FIG. 1 is a block diagram illustrating the main components of a multimedia data processing device according to one embodiment of the present invention. The multimedia data processing device 10 shown in FIG. 1 is a device for creating multimedia data and delivering it to a client terminal 12, and includes a data-for-delivery input unit 14, a data storing unit 16, a template storing unit 18, a delivery request receiving unit 20, an image-for-exchange specifying unit 22, a data size adjusting unit 24, a multimedia data creating unit 26, a client terminal identifying unit 28, a multimedia data converting unit 30 and a delivery unit 32. The multimedia data processing device 10 also includes a display unit 34 for displaying a variety of operation menus and data and an operation unit 36 for allowing a user to input operations. The above described blocks are connected with each other so as to send and receive data via a bus 38.

In FIG. 1, a provider terminal 11A creates Web content in which a URL (Uniform Resource Locator) including a command for generating multimedia data is described. This Web content is delivered by a content delivery server 11B to the client terminal 12. The provider terminal 11A also inputs media data for delivery and multimedia template data to the multimedia data processing device 10.

In the data-for-delivery input unit 14, media data for delivery is input, which is intended to be delivered from the provider terminal 11A to the client terminal 12. The data-for-delivery input unit 14 may also include a media reader which reads media data for delivery from recording media such as a CD-ROM. In this embodiment, the media data for delivery is an image (static image or dynamic image) and in the following description the media data for delivery is referred to as an image for delivery. The data storing unit 16 stores the input image for delivery as described above. The template storing unit 18 stores multimedia template data for creating multimedia data using the image for delivery.

The client terminal 12 sends a request for delivery of multimedia data to the multimedia data processing device 10 using the URL described in the Web content delivered from the content delivery server 11B. The delivery request receiving unit 20 receives the request for delivery of multimedia data sent from the client terminal 12. This URL includes a command which specifies multimedia template data and an image for delivery for creating the multimedia data. An example of output of this URL will be described later.

The image-for-exchange specifying unit 22 detects images included in the multimedia template data selected by the above URL and specifies an image for exchange to be exchanged for the image for delivery from among the detected images. The data size adjusting unit 24 performs compression, reduction, color subtraction, trimming, bit rate adjustment, etc. of the image for delivery to adjust the file size of the image for delivery. The data size adjusting unit 24 processes the image for delivery so that its file size is, for example, equal to or smaller than the file size of the image for exchange. The image for delivery processed by the data size adjusting unit 24 is referred to as a processed image for delivery. The multimedia data creating unit 26 creates multimedia data for delivery by exchanging the image for exchange for the processed image for delivery.

The client terminal identifying unit 28 identifies the type of the client terminal 12 (for example, the type of a cellular phone, a personal computer (PC) or a personal digital assistant (PDA)) which sent the request for delivery of the multimedia data to the multimedia data processing device 10. The multimedia data converting unit 30 converts the multimedia data into the multimedia data in a file format or of a file size reproducible or suitable for reproduction at the client terminal 12 based on the type of the client terminal 12. The multimedia data converted in this way is delivered via the delivery unit 32 to the client terminal 12.

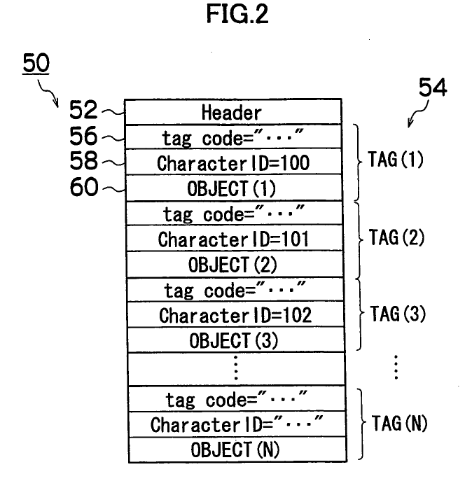

FIG. 2 schematically illustrates the structure of multimedia template data. As shown in FIG. 2, the multimedia template data 50 includes a Header 52 and tags (1,2, . . . ,N) 54.

The Header 52 stores information such as the file size of the multimedia template data 50. The tags 54 respectively include a tag code 56, a CharacterID 58 and an object (1,2, . . . ,N) 60. The CharacterID 58 is a unique code given to the objects 60 included in the multimedia template data 50. The object 60 is either media data or scenario data and its type is specified by the tag code. The media data is data such as character data, image data (static image, dynamic image), audio data, and so on. The scenario data is data that defines timings with which the multimedia data is displayed and reproduced, display positions, display effects (e.g. movement and blinking), and so on.

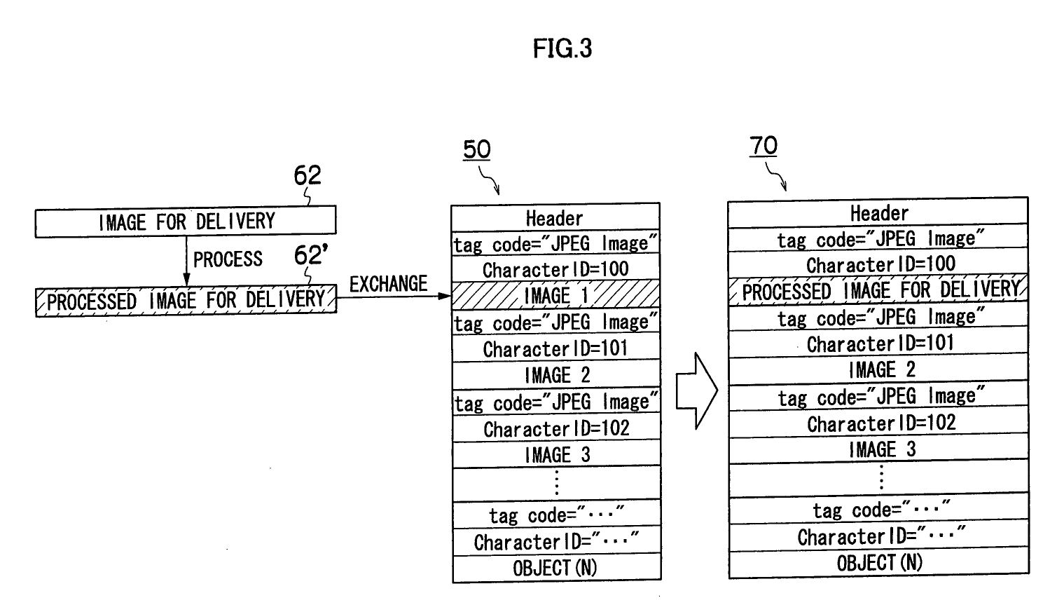

In the following discussion, embodiments of multimedia data processing methods according to the present invention are described with reference to FIGS. 3 to 6. FIG. 3 schematically illustrates a multimedia data processing method according to a first embodiment of the present invention.

First, a request for delivery of multimedia data is sent by the client terminal 12 using a URL within Web content delivered from the content delivery server 1lB. An example of the URL is given below. The file name of the multimedia template data 50 is designated as “sample.swf,” and the file name of the processed image for delivery 62′ is designated as “001.jpg.” The characters “?” and “&” are delimiters between an image file name and an argument, and between arguments, respectively.

Example URL

http://example.xxx.co.jp/aaa/001?FFunc=RF&FFtmpl=sample.swf&FFres=cent ercrop

In the above URL, the argument “FFunc=RF” means that the first image in the multimedia template data 50 “sample.swf” specified by the argument

“FFtmpl=sample.swf is exchanged for the processed image for delivery 62′ “001.jpg.” The argument “FFres=centercrop” indicates a method for reducing the image. It is noted that the extension of the processed image for delivery 62′ “001.jpg.” is omitted in the above described URL.

Next, the image in the multimedia template data specified by the above described URL is detected by the image-for-exchange specifying unit 22 and the first image 1 in the multimedia template data 50 (i.e., the image closest to the Header 52) is specified as the image for exchange. Then, the image for delivery 62 is subjected to compression, reduction, color subtraction or trimming by the data size adjusting unit 24 to generate the processed image for delivery 62′. This processed image for delivery 62′ has been adjusted so that the file size is equal to or smaller than the file size of the image for exchange (image 1).

Further, the image for exchange (image 1) included in the multimedia template data 50 is exchanged for the processed image for delivery 62′ to create multimedia data for delivery 70 by the multimedia data creating unit 26. Then, the type of the client terminal 12 is identified by the client terminal identifying unit 28, and the multimedia data 70 is converted to correspond to the type of the client terminal 12 by the multimedia data converting unit 30 and delivered to the client terminal 12.

According to this embodiment, simply by inputting the image for delivery 62 and specifying the multimedia template data 50, the multimedia data 70 for effectively displaying the image for delivery 62 can automatically be created.

Note that, while the processed image for delivery 62′ is meant to replace the first image of the multimedia template data 50 in the above described embodiment, it may also replace the second, third, etc. image or the last image. Further, the image for delivery 62 may also replace an image within the multimedia template data 50 in the same file format as it, or an image having a file size close to or larger than that of the image for delivery 62. This enables the conversion process of the image for delivery 62 to be eliminated.

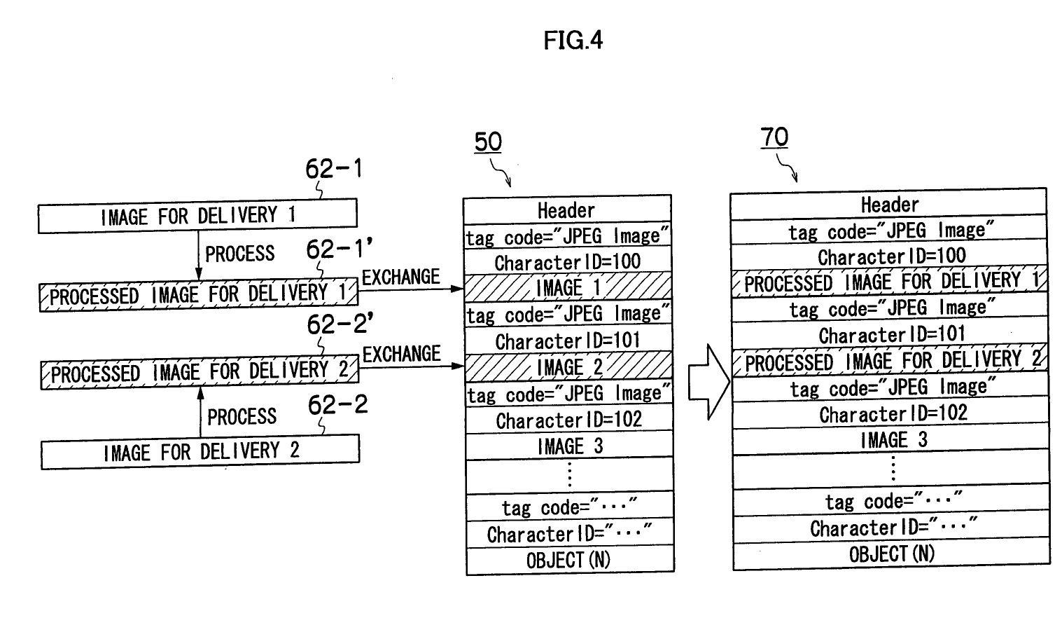

In addition, although there is one image for delivery 62 in the above example of FIG. 3, if there are a plurality of images for delivery (62-1, 62-2, . . . ), as shown in FIG. 4, they may be arranged to replace the images in the multimedia template data 50 in turn from the first or last image. They may also be arranged to replace the images having a file size close to or larger than that of the images for delivery 62-1, 62-2, etc.

If the number of the images for delivery is larger than that of the images in the multimedia template data 50, the number of the images for delivery may be reduced or a message prompting a user to select another multimedia template data 50 may be displayed.

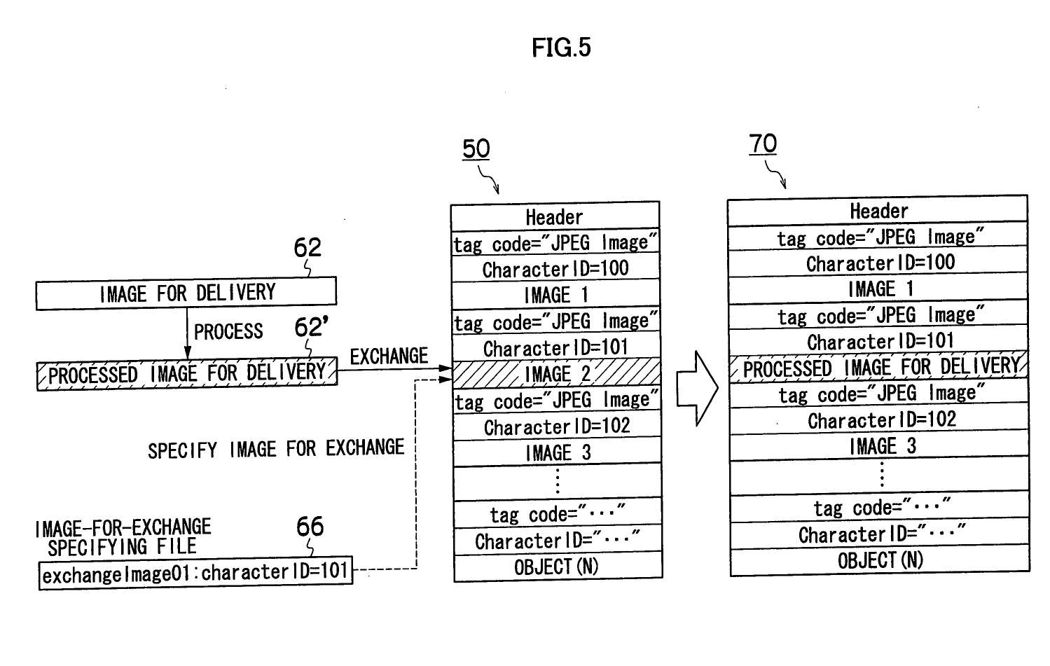

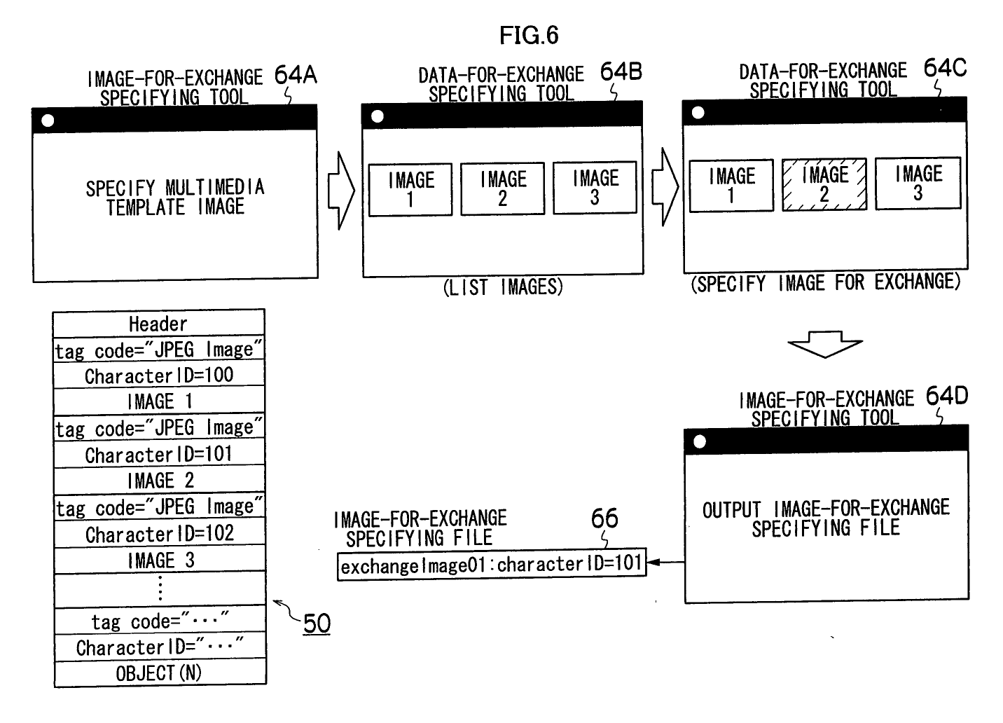

Another multimedia data processing method according to the present invention is now described with reference to FIGS. 5 and 6. FIG. 5 schematically illustrates a multimedia data processing method according to a second embodiment of the present invention.

First, as with the above described embodiment, multimedia template data 50 is specified, based on a URL received by the delivery request receiving unit 20. In this embodiment, the image-for-exchange specifying unit 22 is provided with an image-for-exchange specifying tool 64 shown in FIG. 6. An image-for-exchange specifying file 66 for specifying an image to be exchanged is generated by this image-for-exchange specifying tool 64.

FIG. 6 schematically illustrates the process of generating the image-for-exchange specifying file 66. Note that the reference numerals 64A to 64D in FIG. 6 designate screens displayed on the display unit 34 at the respective steps of the process of generating the image-for-exchange specifying file 66.

After the multimedia template data 50 has first been specified by the URL (screen 64A) as described above, a list of the images included in the multimedia template 50 is displayed (screen 64B). Note that the multimedia template data 50 may also be previewed on this screen 64B so as to check the effects or order of the images to be displayed.

Then, operational input from a user is received by the operation unit 36 and an image for exchange is specified (screen 64C). Then, on the screen 64D, the image-for-exchange specifying file 66 is generated which contains an instruction (command) specifying an image 2 as the image for exchange. As shown in FIG. 6, in the image-for-exchange specifying file 66, the image for exchange is specified using the CharacterID of the tag included in it.

Note that, while the image 2 is selected on the screen 64C of FIG. 6, as many images for exchange as the number of the images for delivery 62 specified by the above described URL and the order of exchange of them may actually be specified.

Referring back to the description of FIG. 5, the image-for-exchange specifying file 66 is then read by the image-for-exchange specifying unit 22, and the image 2 is specified as the image for exchange. Then, the image for delivery 62 is subjected to the predetermined processing by the data size adjusting unit 24 to generate the processed image for delivery 62′ whose file size is equal to or smaller than that of the image for exchange (image 2).

Then, the image for exchange (image 2) included in the multimedia template data 50 is exchanged for the processed image for delivery 62′ by the multimedia data creating unit 26 to create multimedia data 70 for delivery. Further, the type of the client terminal 12 is identified by the client terminal identifying unit 28. Then, the multimedia data 70 is converted to correspond to the type of the client terminal 12 by the multimedia data converting unit 30 and delivered to the client terminal 12.

According to this embodiment, a user can easily specify the images for exchange to be exchanged for the images for delivery 62. This can improve the degree of flexibility in creating the multimedia data 70 and make it easy for a user to create the multimedia data 70 as desired.

Note that, while, in the above described embodiment, the multimedia data is meant to be created after a request for delivery using a URL has been sent from the client terminal 12, multimedia data of different file formats or file sizes corresponding to various types of client terminals 12 may also be created in advance. In this case, the previously created multimedia data of various file formats or file sizes is stored along with information about their correspondence to the types of the client terminals 12 in the data storing unit 16. Then, depending on the type of the client terminal 12 identified by the client terminal identifying unit 28, multimedia data suitable for reproduction is selected and delivered by the delivery unit 32.

While the multimedia template data 50 in the above described embodiment is a SWF file created using Macromedia Flash (Registered Trademark), other formats, such as SVG (Scalable Vector Graphics), may also be used. The format of the image for delivery 62 and the processed image for delivery 62′ may be GIF (Graphic Interchange Format), PNG (Portable Network Graphics) or other format, in addition to the JPEG (Joint Photographic Experts Group) format as described above.

While the multimedia data 70 is created by exchanging the image within the multimedia template data 50 for the image for delivery 62 in the above described embodiment, other data, such as character data, audio data or image data including audio data, can also replace the data within the multimedia template data 50 using the same procedure.

What is claimed is:

1. A multimedia data processing device, comprising:
a template storing device which stores multimedia template data including media data and scenario data which defines the output aspects of the media data,
a data input device which inputs media data for delivery to be delivered to a client terminal,
a template specifying device which specifies multimedia template data to be used to create multimedia data using the input media data for delivery from among the stored multimedia template data,
a media-data-for-exchange specifying device which specifies media data for exchange to be exchanged for the media data for delivery from among the media data included in the multimedia template data, and
a multimedia data creating device which creates the multimedia data by exchanging the media data for exchange for the input media data for delivery.

2. The multimedia data processing device according to claim 1, wherein
the media-data-for-exchange specifying device specifies as the media data for exchange the first or last media data included in the specified multimedia template data.

3. The multimedia data processing device according to claim 1, wherein
the media-data-for-exchange specifying device specifies as the media data for exchange the media data included in the specified multimedia template data in turn from the first or last media data.

4. The multimedia data processing device according to claim 2, wherein
the media-data-for-exchange specifying device specifies as the media data for exchange the media data included in the specified multimedia template data in turn from the first or last media data.

5. The multimedia data processing device according to claim 1, wherein
the media-data-for-exchange specifying device specifies as the media data for exchange the media data having a file size close to or smaller than the file size of the input media data for delivery among the media data included in the specified multimedia template data.

6. The multimedia data processing device according to claim 1, further comprising:
an operational input receiving device which receives an operational input from a user, wherein
the multimedia data creating device specifies as the media data for exchange the media data specified by the operational input.

7. The multimedia data processing device according to the claim 1, wherein
the media data and the media data for delivery is respectively at least one of character data, static image data, dynamic image data or audio data.

8. The multimedia data processing device according to the claim 1, further comprising a file size adjusting device which performs at least one of compression, reduction, color subtraction, or bit rate adjustment so that the file size of the input media data for delivery is equal to or smaller than the file size of the media data for exchange to be exchanged for the media data for delivery.

9. The multimedia data processing device according to the claim 2, further comprising a file size adjusting device which performs at least one of compression, reduction, color subtraction, or bit rate adjustment so that the file size of the input media data for delivery is equal to or smaller than the file size of the media data for exchange to be exchanged for the media data for delivery.

10. The multimedia data processing device according to the claim 3, further comprising a file size adjusting device which performs at least one of compression, reduction, color subtraction, or bit rate adjustment so that the file size of the input media data for delivery is equal to or smaller than the file size of the media data for exchange to be exchanged for the media data for delivery.

11. The multimedia data processing device according to the claim 5, further comprising a file size adjusting device which performs at least one of compression, reduction, color subtraction, or bit rate adjustment so that the file size of the input media data for delivery is equal to or smaller than the file size of the media data for exchange to be exchanged for the media data for delivery.

12. The multimedia data processing device according to the claim 6, further comprising a file size adjusting device which performs at least one of compression, reduction, color subtraction, or bit rate adjustment so that the file size of the input media data for delivery is equal to or smaller than the file size of the media data for exchange to be exchanged for the media data for delivery.

13. The multimedia data processing device according to the claim 7, further comprising a file size adjusting device which performs at least one of compression, reduction, color subtraction, or bit rate adjustment so that the file size of the input media data for delivery is equal to or smaller than the file size of the media data for exchange to be exchanged for the media data for delivery.

14. The multimedia data processing device according to the claim 1, further comprising:
an identifying device which identifies the type of the client terminal upon receipt of a request for delivery from the client terminal,
a data converting device which converts the created multimedia data into the multimedia data in a format suitable for reproduction corresponding to the type of the client terminal, and
a delivery device which delivers the converted multimedia data to the client terminal.

15. The multimedia data processing device according to the claim 2, further comprising:
an identifying device which identifies the type of the client terminal upon receipt of a request for delivery from the client terminal,
a data converting device which converts the created multimedia data into the multimedia data in a format suitable for reproduction corresponding to the type of the client terminal, and
a delivery device which delivers the converted multimedia data to the client terminal.

16. The multimedia data processing device according to the claim 3, further comprising:
an identifying device which identifies the type of the client terminal upon receipt of a request for delivery from the client terminal,
a data converting device which converts the created multimedia data into the multimedia data in a format suitable for reproduction corresponding to the type of the client terminal, and
a delivery device which delivers the converted multimedia data to the client terminal.

17. The multimedia data processing device according to the claim 5, further comprising:
an identifying device which identifies the type of the client terminal upon receipt of a request for delivery from the client terminal,
a data converting device which converts the created multimedia data into the multimedia data in a format suitable for reproduction corresponding to the type of the client terminal, and
a delivery device which delivers the converted multimedia data to the client terminal.

18. The multimedia data processing device according to the claim 6, further comprising:
an identifying device which identifies the type of the client terminal upon receipt of a request for delivery from the client terminal,
a data converting device which converts the created multimedia data into the multimedia data in a format suitable for reproduction corresponding to the type of the client terminal, and
a delivery device which delivers the converted multimedia data to the client terminal.

19. The multimedia data processing device according to the claim 7, further comprising:
an identifying device which identifies the type of the client terminal upon receipt of a request for delivery from the client terminal,
a data converting device which converts the created multimedia data into the multimedia data in a format suitable for reproduction corresponding to the type of the client terminal, and
a delivery device which delivers the converted multimedia data to the client terminal.

20. The multimedia data processing device according to the claim 8, further comprising:
an identifying device which identifies the type of the client terminal upon receipt of a request for delivery from the client terminal,
a data converting device which converts the created multimedia data into the multimedia data in a format suitable for reproduction corresponding to the type of the client terminal, and
a delivery device which delivers the converted multimedia data to the client terminal.

21. A multimedia data processing method comprising the steps of:
storing multimedia template data including media data and scenario data which defines the output aspects of the media data,
inputting media data for delivery to be delivered to a client terminal,
specifying multimedia template data to be used to create multimedia data using the input media data for delivery from among the stored multimedia template data,
specifying media data for exchange to be exchanged for the media data for delivery from among the media data included in the multimedia template data, and
creating the multimedia data by exchanging the media data for exchange for the input media data for delivery.

22. A multimedia data processing program, causing a computer to implement the functions of:
storing multimedia template data including media data and scenario data which defines the output aspects of the media data,
inputting media data for delivery to be delivered to a client terminal,
specifying multimedia template data to be used to create multimedia data using the input media data for delivery from among the stored multimedia template data,
specifying media data for exchange to be exchanged for the media data for delivery from among the media data included in the multimedia template data, and
creating the multimedia data by exchanging the media data for exchange for the input media data for delivery.
